(19) United States
(12) Patent Application Publication
(10) Pub. No.: US 2022/0381199 A1
(43) Pub. Date: Dec. 1, 2022

(54) SLOTTED DISPLACER SYSTEM FOR STIRLING ENGINES

(71) Applicant: Archibald James DeMone, Westford, MA (US)

(72) Inventor: Archibald James DeMone, Westford, MA (US)

(21) Appl. No.: 17/334,719

(22) Filed: May 29, 2021

(51) Int. Cl. F02G 1/055

(52) U.S. Cl. CPC F02G 1/055

(57) ABSTRACT

The disclosed slotted displacer system for Stirling engines provides a large surface area and working volume for an engine that operates at a lower temperature differential to compensate for the lower temperature differential available in some applications.

### BACKGROUND OF THE INVENTION

An increase it the miles per gallon performance of vehicles powered by internal combustion engines reduces the cost of operation of the vehicles and reduce their carbon footprint. This can be accomplishes by the recovery of the energy in the exhaust systems of the vehicles using a Stirling engine. This invention provides a means of building a Stirling engine that meets the conditions available and the reliability and cost required for that application.

This invention provides a large surface area required to transfer the heat needed in a larger operating volume.

For example, the Philips Company built a 10 horse power Stirling engine with a 6 cubic inch displacer volume, C. M. Hargreaves (1991). The Philips Stirling Engine. Elsevier Science. ISBN 0-444-88463-7. It used an open flame as a heat source so the high temperature to low temperature ratio was approximately 3:1. In an automotive application of a Stirling engine used to recover energy from the waste heat of the exhaust gases from a gasoline engine, the operating temperature of a catalytic converter results in a high temperature to low temperature ratio of approximately 2:1. Since the pressure-volume generated is proportional to the square of the high temperature to low temperature ratio, a volume increase of 2.25 can help compensate for the lower ratio. In addition, a larger increase in volume can also allow for a more practical Stirling engine by allowing a reduction in operating speed and/or a reduction of the operating pressure.

The slotted displacer system can be used in many Stirling engine configurations and the displacer can be moved by mechanical, electrical, pneumatic or hydraulic means. A double action floating piston configuration driving a linear generator allows for a completely sealed engine with a noncritical piston to cylinder seal.

### BRIEF SUMMARY OF THE INVENTION

This invention is a displacer system used in a Stirling engine with a large surface area capable of transferring heat to and from the working gas of a large operating volume.

This allows the construction of an engine that substitutes operating volume for high temperature to low temperature ratio, operating pressure and/or operating speed.

The displacer is constructed of a number of high surface area fins that mesh with the heat exchangers fins, thereby forcing the operating gas from either the hot side heat exchanger or cold side heat exchange which moves the operating gas to the opposite heat exchanger. The surface areas of the displacer fins also exchange heat to and from the working gas since they are in contact with their associated heat exchange part of the cycle time and approach their heat exchangers temperature. A gap filling material can be used to help with the heat transfer between the displacer fins and their associated heat exchanger fins.

The drawing depict rectangular shaped fins in a rectangular pattern but they can be any shape and any pattern suitable for the application. It is the fins surface areas and their spacing that determine the performance of the device.

### BRIEF DESCRIPTIONS OF THE DRAWINGS

For a fuller understanding of the nature and objects of the present invention, reference should be made to the following detailed descriptions taken in connection with the accompanying drawings in which the same reference numerals are used to indicate the same or similar parts wherein:

FIG. 1 shows an exploded view of the parts of the invention involved in the transfer of heat to and from the working gas of the engine.

FIG. 2 shows the displacer in the position that exposes the working gas to the surface areas of the cold side heat exchanger fins and of the cold side displacer fins.

FIG. 3 shows the displacer in the position that exposes the working gas to the surface areas of the hot side heat exchanger fins and of the hot side displacer fins.

### DETAILED DESCRIPTION OF THE DRAWINGS

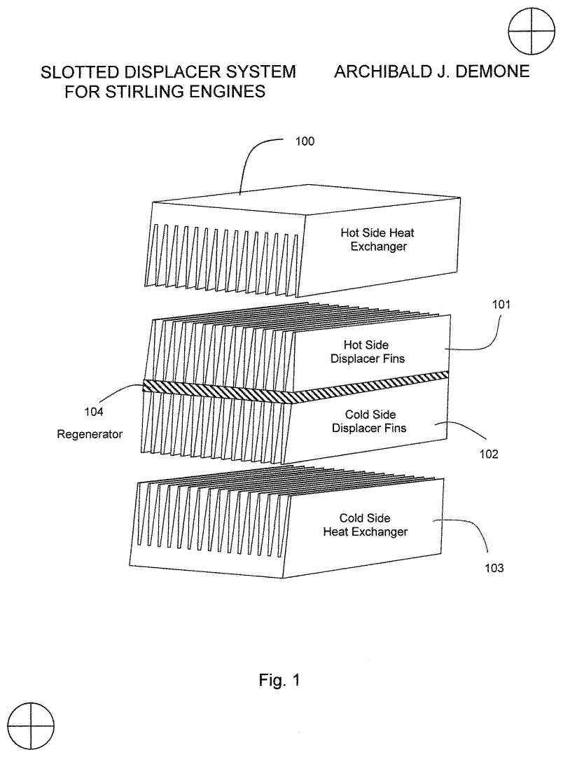

FIG. 1 shows an exploded view of the parts of the invention involved in the transfer of heat to and from the working gas of the engine. Heat exchanger 100 is thermally connected to the heat source of the engine. Hot side displacer fins 101 displace the operating gas from the spaces between the hot side fins when it is positioned against the hot side heat exchanger and heat is conducted from the hot side heat exchanger fins to the hot side displacer fins.

Heat exchanger 103 is thermally connected to the cold source of the engine. Cold side displacer fins 102 displace the operating gas from the spaces between the cold side fins when it is positioned against the cold side heat exchanger and heat is conducted from the cold side displacer fins to the cold side heat exchanger fins.

Regenerator material 104 absorbs heat from the operating gas as it passes from the hot side to the cold side and it conducts heat to the operating gas as it passes from the cold side to the hot side of the engine.

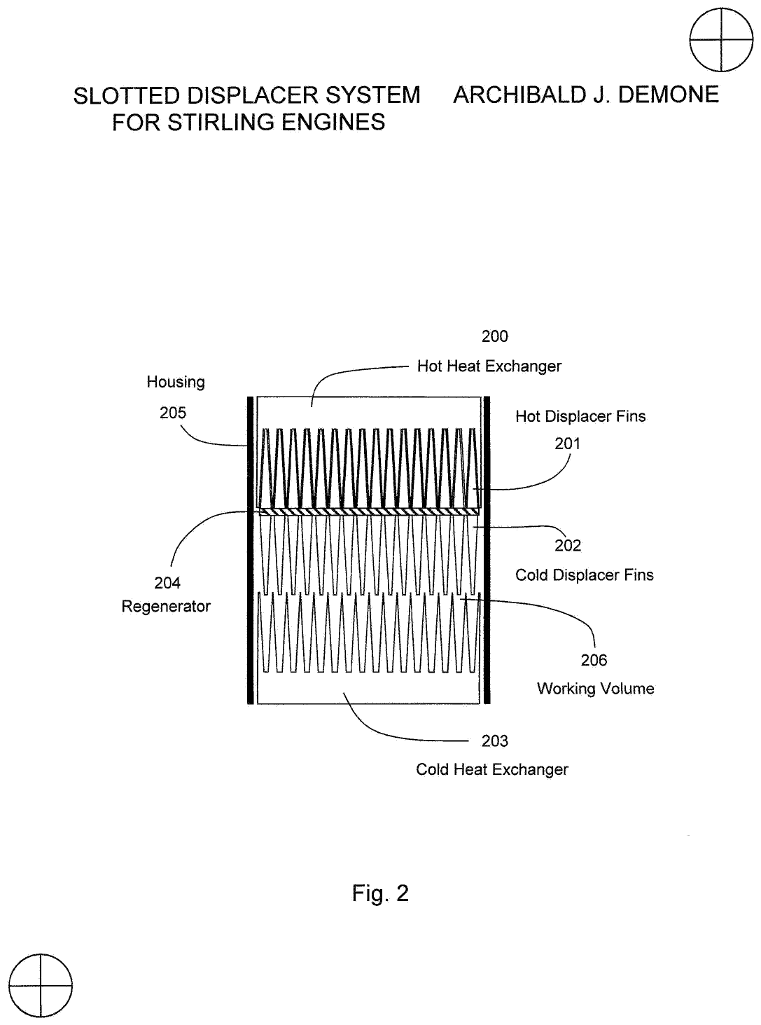

FIG. 2 shows the displacer engaged with the hot side heat exchanger 200. With the displacer in this position, the operating gas is forced out of the space between the fins of the hot side heat exchanger 200 and between the fins of the hot side displacer 201 causing it to move through the regenerator material 204 to the space between the cold side heat exchanger fins 203 and the cold side displacer fins 202. Heat is then conducted away from the operating gas to the cold side heat exchanger fins 203 and the cold side displacer fins 202. Heat is also conducted from the hot side heat exchanger fins 200 to the hot side displacer fins 201.

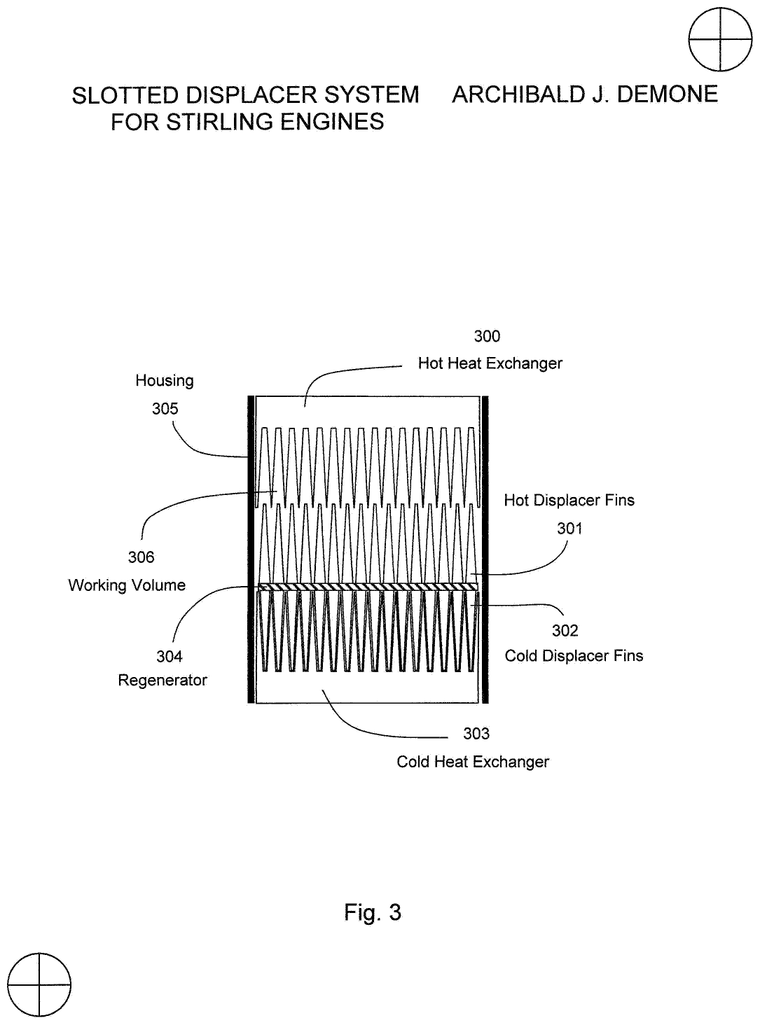

FIG. 3 shows the displacer engaged with the cold side heat exchanger 303. With the displacer in this position, the operating gas is forced out of the space between the fins of the cold side heat exchanger 303 and between the fins of the cold side displacer 302 causing it to move through the regenerator material 304 to the space between the hot side heat exchanger fins 300 and the hot side displacer fins 301. Heat is then conducted into the operating gas from the hot side heat exchanger fins 300 and the hot side displacer fins 301. Heat is also conducted from the cold side heat displacer fins 302 to the cold side heat exchanger fins 303.

Since certain changes may be made in the above apparatus without departing from the scope of the invention herein involved, it is intended that all matter contained in the above description or shown in the accompanying drawings shall be interpreted in an illustrative and not a limiting sense.

What is claimed is:

1. A high surface area displacer assembly comprising:
(A) An external enclosure defining an interior cavity;
(B) High surface area finned heat exchangers;
(C) High; surface area displacer fins that mesh with high surface area heat exchangers fins.
